(19) United States
(12) Patent Application Publication
(10) Pub. No.: US 2016/0004619 A1
(43) Pub. Date: Jan. 7, 2016

(54) AUTOMATED MAINTENANCE OF AN ELECTRONIC DEVICE

(71) Applicant: Apple Inc., Cupertino, CA (US)

(72) Inventors: Fletcher R. Rothkopf, Cupertino, CA (US); Haran Balaram, Cupertino, CA (US)

(21) Appl. No.: 14/323,425

(22) Filed: Jul. 3, 2014

(51) Int. Cl. G06F 11/30

(52) U.S. Cl. CPC G06F 11/3058; G06F 11/3051; G06F 11/3055

(57) ABSTRACT

A method and system for performing maintenance, repair and recalibration functions on a portable electronic device so as to be undetected by a user. The portable electronic device senses when a user is not in close proximity to the device or when the device is otherwise in an environment which will make the performance of the functions undetectable by a user.

### TECHNICAL FIELD

The embodiments disclosed herein relate to the field of portable electronic devices. More particularly, the embodiments relate to performing maintenance and repair services on portable electronic devices. In still greater particularity, the embodiments relate to performing maintenance or repair services on a portable electronic device during device downtime or when the device is in an environment where a user would not detect that the services are being performed and at a time unknown to a user.

### BACKGROUND

Portable electronic devices such as smartphones, tablets, laptop computers and the like have become ubiquitous in recent years. Because users have grown accustomed to carrying these devices and relying on them for timekeeping, location, information, internet access and many other uses, users carry these devices in many environments and during most time periods of the day. Users carry these devices while travelling in automobiles, on buses, trains, and on airplanes and while engaging in strenuous activities such as running, climbing and the like as well as during other less strenuous activities. Because users are in possession of these devices in many environments, these devices may sometimes be exposed to environmental elements such as water, wind, dust and electromagnetic interference events which can alter the performance of certain components of the device.

Many modern portable electronic devices incorporate various sensor devices such as an accelerometer and gyrometer into the portable electronic device to detect speed and direction of movement. Other sensor devices such as light sensors, proximity sensors and optical sensors for detecting position and various other purposes are included in these devices. These sensors are useful to enhance various functionalities of the portable electronic device. For example, an accelerometer is a device that can measure the force of acceleration, whether caused by gravity or by movement. Because an accelerometer senses movement and gravity, it is increasingly being incorporated into personal electronic devices to detect the orientation of the device, for example, a display screen. This allows the portable electronic device to automatically adjust the visual output to make it appropriate to the direction of the screen to allow for landscape and portrait view on a screen. In this way, a user can view lists with the screen held vertically and watch videos with the screen held sideways. Gyrometers may be included to assist in the determination by accelerometers.

Because of the increasing amount of services and applications demanded by users of portable electronic devices the types and sophistication of the sensing elements contained therein is increasing. By subjecting the portable electronic devices to shock and environmental conditions such as those described above, users risk damage to the components in these devices. Such damage can result in poor or no performance of the portable electronic device. Exposure to environmental elements may take its toll on the portable electronic devices which necessitates increased maintenance, recalibration and repair services to the portable electronic devices. This increase in service requirements can become an annoyance to a user of the portable electronic device and can result in significant user dissatisfaction. These maintenance and repair services may be time consuming to perform and result in unavailability of certain services and user down time which may be unacceptable to many users who rely on these devices during, and as part of, their daily routines and activities.

### SUMMARY

Generally, embodiments described herein disclose systems and methods for performing maintenance and other services on a portable electronic device. The portable electronic device includes various sensors which may provide information on the status of the portable electronic device. That is, the sensors may detect whether the device is in use or is in an environment where services may be performed without detection by a user or without inconvenience to that user. If a maintenance situation is identified, the maintenance or other repair may be performed without interrupting the user's normal routine. That is, the maintenance services may be performed if the device determines that it is not being used such as when the user is sleeping or is engaged in other activities which would make the user unaware that such maintenance or remedial operations are being performed. In another embodiment, the device is determined to be in an environment (noisy, low light, and so on) which would make it optimal for performing certain services without disruption to, or detection by, a user.

### BRIEF DESCRIPTION OF THE DRAWINGS

FIG. 1 is a perspective view of a portable electronic device;

FIG. 2 is a perspective view of a portable electronic device held by a user;

FIG. 3 is a view of a portable electronic device in a noisy environment;

FIG. 4 is a view of a portable electronic device shown while a user is sleeping;

FIG. 5 is a flow chart of one method for performing maintenance; and

FIG. 6 is a flow chart of another method for performing maintenance.

### DETAILED DESCRIPTION

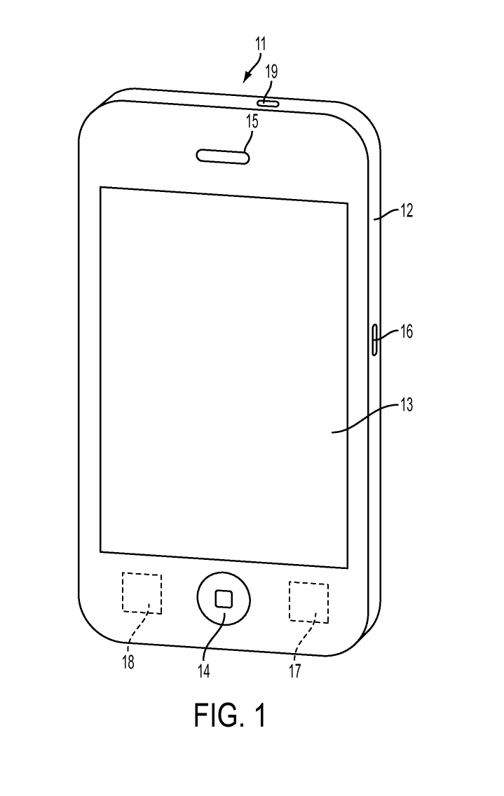

Referring to the figures wherein like reference numbers denote like structure throughout the specification, FIG. 1 is a perspective view of an electronic device such as a smartphone 11 is shown. Smartphone 11 includes a housing 12 to contain various electronic components including a display screen 13 which may be a touchscreen used to display images. In addition, housing 12 includes various controls and features such as a home button 14 and a speaker 15 as well as camera activation button 16 and an on/off button 19. Home button 14 may be used to sense user contact and sense a fingerprint of the user so as to provide identity verification. Other controls not shown include volume adjustment, microphone and camera controls including flash and shutter mechanism as are known in the art may be included on the sides or backside of housing 12 and are not shown in this view of smartphone 11. Icons for accessing and using various applications (apps) and dialing telephone numbers etc. may be displayed on touchscreen 13.

A control device 17 in housing 12 may execute instructions and carry out operations associated with portable electronic devices as are described herein. Using instructions from device memory, controller 17 may regulate the reception and manipulation of input and output data between components of the electronic device. Controller 17 may be implemented in a computer chip or chips. Various architectures can be used for controller 17 such as microprocessors, application specific integrated circuits (ASIC's) and so forth. Controller 17 together with an operating system may execute computer code and manipulate data. The operating system may be a well-known system such as iOS, Windows, Unix or a special purpose operating system or other systems as are known in the art. Control device 17 may include memory capability to store the operating system and data. Control device 17 may also include application software to implement various functions associated with the portable electronic device 11.

In addition to functioning as a portable telephone, smartphone 11 can record video, take photos, play music, and perform Internet functions such as web-browsing and emailing. Other functions of smartphone 11, including playing games, GPS navigation, social networking, and the like, can be enabled by downloading and installing software applications commonly known as “apps”. The versatility and wide range of available services make smartphones increasingly popular devices and thus they are almost always carried on the person of users and increasingly utilized for various purposes in a wide range of environments. Many users are only without their smartphones during limited times of the day and most often at night when the user is sleeping, although, even then, the smartphone may be kept close due to its alarm clock functionality.

Smartphone 11 may include various sensors 18 contained within housing 12. Examples of such sensors 18 include a 3-axis accelerometer to sense the orientation of smartphone 11 and change the orientation of screen 13 accordingly, allowing the user to easily switch between portrait and landscape mode. Another type of sensor 18 may be a gyroscopic sensor to sense the amount and direction of movement of the smartphone and along with the accelerometer may sense various shaking or other smartphone movements and can also be used to control various apps including games. Another sensor 18 may be a proximity sensor included to deactivate touchscreen 13 when the device is brought near the user's face during a telephone call. This is done to save battery power and to prevent inadvertent inputs on touchscreen 13 from the user's face and ears. Another sensor 18 may be an ambient light sensor (ALS) 18 to adjust display screen 13 brightness to brighten the display in brightly lit environments and dim the display screen 13 in low light which in turn saves battery power. Another sensor 18 may be a magnetometer sensor included to measure the strength and/or direction of the magnetic field in the vicinity of the smartphone 11. Because certain devices or radio signals can interfere with the operation of smartphone 11, users either move away from the interference or re-calibrate smartphone 11 by moving it in a FIG. 8 motion. Liquid contact sensors may also be included as a sensor 18 to detect when smartphone 11 has come into contact with moisture. A programmable pulse generator (PPG) may also be included as one of sensors 18. In some portable electronic devices, an ultrasound sensor may be included to detect people and objects by emitting high frequency sound waves outside the range of human hearing. It should be appreciated that any reference to the operation of “sensors” in the plural is intended to cover the operation of a single sensor performing the same function, and vice versa.

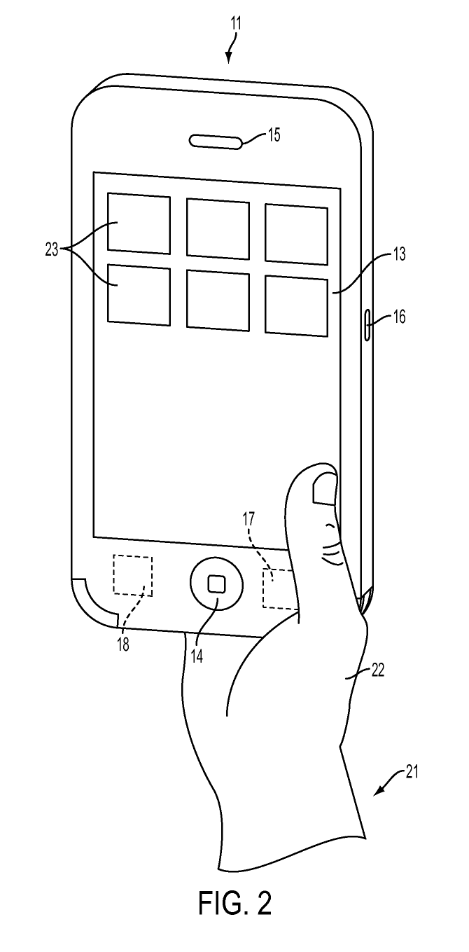

Referring to FIG. 2, smartphone 11 is held in the hand of a user 21. User 21 may activate and use smartphone 11 by interacting with various controls including home button 14 and camera activation button 16. User 21 may also interact with smartphone 11 through touchscreen 13. For example, user 21 may use his or her thumb 22 to select from among icons 23 on touchscreen 13 or to utilize control buttons 14, 16 etc. Controller 17 may provide access to various apps through icons 23 which in turn provide user 21 with desired functionality. Proximity sensor 18 detects the proximity of user 21 to smartphone 11 as described above so as not to cause inadvertent contact with icons 23.

Because of extensive use of smartphone 11 by user 21, various self-maintenance activities may need to be performed on and by smartphone 11 to continue to provide various functionalities to user 21. For example, in some environments and applications, smartphone 11 may have been exposed to liquids. That is, because user carries smartphone 11 along with him or her, including many times to meals, a beverage may have been spilled on or near smartphone 11 by a user 21 such that precipitation may have entered speaker 15 which would interfere with its normal operation. In order to clear this water from speaker 15, a special tone may be initiated by smartphone 11 which causes speaker 15 to vibrate and expel the moisture from speaker 15. While useful to clear moisture from speaker 15, the special tone initiated by controller 17 to clear speaker 15 may prove bothersome to user 21 and may need to be performed when user 21 is not in audio range of smartphone 11 as determined by sensors 18 and controller 17. Sensors 18 such as proximity sensors, accelerometer, ambient light sensor and a microphone in smartphone 11 may be used to determine when user 11 is not in audio range of smartphone 11 and the maintenance operation may be initiated in that instance. In another embodiment, testing for moisture in speaker 15 may require that smartphone 11 play certain sounds through speaker 15 and this testing may also be done periodically when smartphone has been detected to be in an appropriate venue for such testing as determined by sensors 18 in conjunction with controller 17.

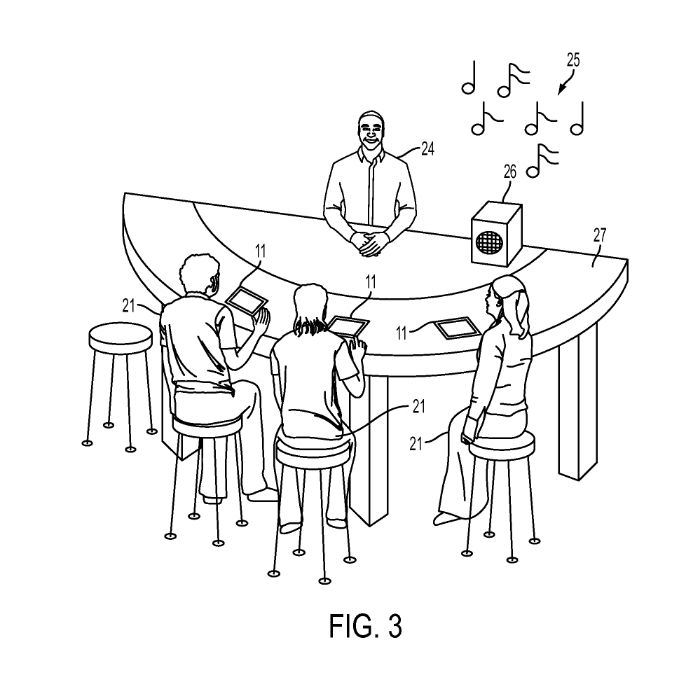

Referring to FIG. 3, in another embodiment, one or more of sensors 18 such as a microphone may determine that smartphone 11 is in a noisy environment such as a crowded street or a noisy entertainment venue or the like. In this embodiment, one such environment may be an entertainment venue where a disc jockey 24 is playing music 25 from a loudspeaker 26 in a sufficient volume such that users 21 may not be able to hear any noise from smartphones 11. In this noisy environment, for example, a moisture clearing operation may be performed so that any noise made by the operation will not be heard by user 21 due the level of background noise from the sensed noisy environment. The noisy environment is determined by sensors 18 and controller 17 by determining that the detected noise level exceeds a predetermined threshold. In this embodiment, various sensors 18 including a microphone, in conjunction with controller 17, have determined that the level of background noise is sufficient, and has been sufficient for a predetermined time and likely will remain sufficient, such that it is likely that various maintenance or repair activities that would otherwise be audibly apparent to users 21 can be performed on smartphone 11 without user detection. In another embodiment, a high frequency vibration may also be used to clear water from the speaker such that the user will not feel the vibration. In this embodiment, sensors 18, including accelerometer sensors and proximity sensors, detect that certain smartphones 11 are lying on a table 27 or other inanimate object and are not likely in contact with the hands of users 21.

Another repair operation that must be periodically performed to screen 13 is to repair LED (Light Emitting Diode) burn in or a bright or dark pixel on screen 13 or missing or artifact lines in a video display on screen 13. In order to perform these operations, screen 13 must be cycled through various light colors and/or various patterns must be cycled across screen 13 to repair the LED point source. This process may take up to several hours to complete. If this operation is done while user 21 was trying to view screen 13, significant disruption would occur because screen 13 would be cycling and interfere with user's visual recognition of images on screen 13. Sensors 18 such as a proximity sensor, a light sensor and an optical sensor may be used to detect when user 21 has left a room or when a suitable low light environment (i.e. dark room, device in a pocket, purse or other closed container) is sensed to perform these operations so as not to be disruptive to the user.

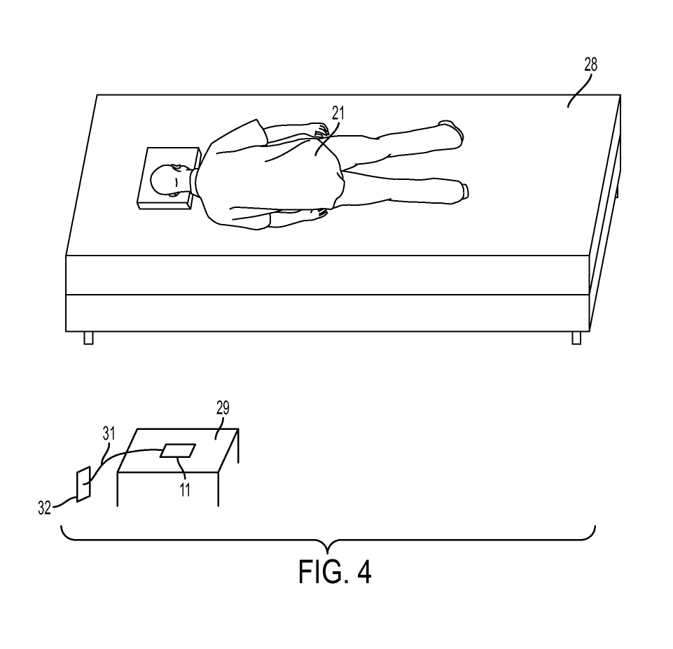

Referring to FIG. 4, in another embodiment, a user's sleeping time may also be an excellent time to perform certain operations and the above sensors 18 along with an alarm clock app on smartphone 11 may be used to determine normal sleeping times of a user 21. In this embodiment user 21 is asleep on a bed 28 while smartphone 11 is resting on a table 29. While table 29 is shown adjacent bed 28, it can be appreciated that table 29 could be located in another room. In another embodiment, smartphone 11 may also be connected to a charging device 31 plugged into wall socket 32. Controller 17 may determine user 21 sleeping times through the use of various smartphone sensors 18 and the sleeping/waking times set by user 21 through the alarm function on smartphone 11. Certain maintenance or recalibration can be performed during those times. Once user 21 is determined to have come back into the room or is awakened or otherwise in close visual proximity to screen 13, the maintenance or recalibration activities may be suspended or concluded until sensors 18 in conjunction with controller 17 again detect an appropriate time to conduct these activities. In another embodiment, sensors 18 may detect when smartphone has been in a pocket or purse of user 21 so as to be visually undetectable to user 21 such that screen maintenance or recalibration activities may be performed undetected. Controller 17 determines the appropriate time for such activities when, after a period of time exceeding a predetermined threshold, it can reasonably be determined that screen 13 is not being visually observed by user 21. In another embodiment, sensors 18 and controller 17 may determine when smartphone 11 has moved from a bright to a dark environment (or vice versa) such as into or out of a room or building and this information may signal an appropriate time to conduct various maintenance operations.

In another embodiment, when user 21 plugs smartphone 11 into a battery charger, user 21 expects some noise and vibration so maintenance operations may be performed during the time that controller 17 determines that smartphone 11 is being recharged (for example, is placed on a charging dock or plugged into a power source). As one example recalibration, which requires device vibration, could be performed during this time without user 21 being aware that this operation is occurring. In this environment, speaker testing and recalibration may also be performed undetected by user 21. Similarly, speaker recalibration may be performed when the device detects that no users are nearby through operation of various sensors, as described elsewhere herein.

Another maintenance operation that may be periodically performed by smartphone 11 is actuator vibration recalibration and performing this operation during recharging makes the maintenance virtually undetectable to user 21. Likewise, if the device detects that it is in a particularly noisy environment (for example through operation of the microphone) or is experiencing frequent motion (for example, through operation of an accelerometer, gyroscope, magnetometer or other motion sensor), the device may determine to initiate actuator recalibration because the noise and/or motion may mask the noise and/or motion generated by the actuator during recalibration operations.

In another embodiment, when user 21 has received one or more audio or vibration signals indicating that one or more audio or electronic messages have been received or have been awaiting a response for a predetermined length of time, sensors 18 including a microphone and controller 17 may determine that user 21 is not likely in contact with or in proximity to smartphone 11 and various activities could be initiated to repair and/or recalibrate various functions and devices on smartphone 11. For example, the microphone may detect that the environment is quiet and thus the device may determine that no user or other person is nearby; such determination may be made if the relative quiet persists for a certain period of time. Similarly, an optical sensor could be used to determine that no user or person is within range of the optical sensor. A proximity sensor and/or ambient light sensor may likewise be used for such determinations, for example by measuring a steady state of lighting conditions, lack of shadows cast by persons, and so on.

In another embodiment, the camera function of smartphone 11 may be maintained in various situations. For example, when significant visual quiet time has been determined by sensors 18 in conjunction with controller 17, the focal point of the camera may be adjusted. An optical image stabilizer (OIS) is a mechanism used in a still or video camera in smartphone 11 to stabilize a recorded image by varying the optical path to an image sensor 18. This technology is implemented in the lens itself, or by moving the optical sensor 18 within the optical path. Optical stabilization systems operate to stabilize the image projected on the sensor before the sensor converts the image into digital information. Image stabilization reduces blurring associated with the motion of a camera during exposure. Specifically, it compensates for angular movement usually due to movement of smartphone 11 during image recording. The OIS must periodically recalibrate itself and this recalibration must be performed when user 21 is not otherwise using the camera or video functions of smartphone 11. By implementing the recalibration when sensors 18 and controller 17 have determined that such operations on smartphone 11 would not be detectable to user 21, the recalibration of OIS may be accomplished without inconveniencing user 21.

In addition to the camera maintenance functions discussed above, other issues such as image quality may require remedial measures to be taken which, if done when smartphone 11 is in downtime mode, will be unknown to, and will not inconvenience user 21. For example, if touchscreen 13 shows a closed lens or a black screen when in camera mode, this problem may be corrected by cycling into and out of the camera mode and/or turning smartphone off and then back on to reset the camera function. These operations may interfere with the normal operation of smartphone 11 and be disruptive to user 21. If these operations were done when user 21 was remote from smartphone 11 or otherwise oblivious to their occurrence then this would enhance user's experience. Maintenance or repair issues may also arise with respect to various accessories on smartphone 11 such with a headset or wireless headphone technologies for exchanging data over short distances using short-wavelength radio waves from fixed and mobile devices. In order to reset such functions, smartphone 11 may need to be cycled off and on or the wireless headphone application may need to be turned off and on. Again, these operations may be accomplished while the user is sensed as being remote from smartphone 11 or when sensors 18 in conjunction with controller 17 determine that smartphone 11 is in a (noisy or busy) environment such that performing these remedial maintenance or recalibration function will not be detectable by, or inconvenience, user 21.

In another embodiment, ambient light sensor (ALS) 18 may need maintenance or recalibration which must be performed when user 21 is not visually interacting with screen 13 as described above with respect to maintaining the camera functions. Malfunctioning of ALS sensor 18 could result in no backlight on screen 13 or a totally dark screen 13. To alleviate this problem smartphone 11 may cycle through a series of steps to test ALS 18 such as checking the brightness level, activating the sleep/wake button, turning the smartphone 11 on and off and similar measures. These measures take time and detract from normal operation of smartphone 11 and thus it is a significant advantage and convenience to user 21 if these recalibration and maintenance operations can be performed during down time when user 21 is not interacting with smartphone 11 or when these activities are otherwise undetectable to user 21.

In some situations, call or connection issues may result in reduced or nonexistent telephone service. The network settings on smartphone 11 may need to be reset as a precautionary or corrective measure if cellular coverage is determined to be at risk. This operation may result in some minutes of not being able to make or receive telephone calls or text or email messages and thus it would be preferable if this reset operation could be performed during a downtime event. Similarly smartphone 11 could be cycled on and off to restore the “airplane mode” if controller 17 determines that this function has been compromised. As discussed above, smartphone 11 includes magnetometer sensor 18 to measure the strength and/or direction of the magnetic field in the vicinity of the smartphone 11 and it can be re-calibrated by user 21 moving it in. In another embodiment, by vibrating smartphone 11 to re-calibrate it, this operation can be accomplished during a downtime event so as not to inconvenience user 21 when he or she wishes to utilize the wireless communication function of smartphone 11.

Certain of the smartphone controls may require recalibration or maintenance from time to time. For example, home button 14 may be slow to respond or stop working. In order to correct this problem smartphone 11 may be cycled on and off to restore the home button function or smartphone 11 may be put in a “sleep” mode. Either of these maintenance or repair operations could be performed while smartphone 11 is in a downtime situation and thus user 21 will not be inconvenienced and may not even be aware that the maintenance or repair operation has been accomplished.

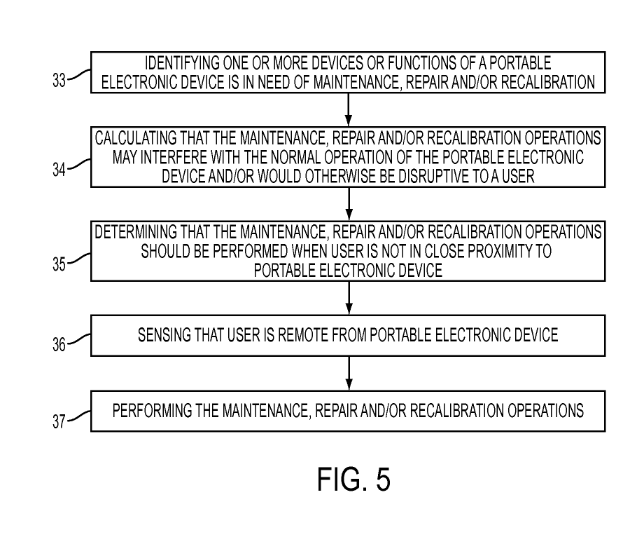

Referring to FIG. 5 a flow chart of one embodiment of a service or maintenance process is disclosed. In this embodiment, in step 33, controller 17 determines that one or more devices or functions of smartphone 11 are not operating properly or are otherwise in need of maintenance, repair and/or recalibration. At step 34, controller 17 calculates that these of maintenance, repair and/or recalibration operations are such that they would interfere with the normal operation of the portable electronic device and/or would otherwise be disruptive to a user. At step 35, controller determines that the maintenance, repair and/or recalibration operations should be performed when user 21 is not in close proximity to portable electronic device 11. At step 36, controller 17 and sensors 18 determine that user 21 is remote from portable electronic device 11. At step 37, controller 17 directs that the maintenance, repair and/or recalibration operations are performed for as long as user 21 remains remote from the portable electronic device.

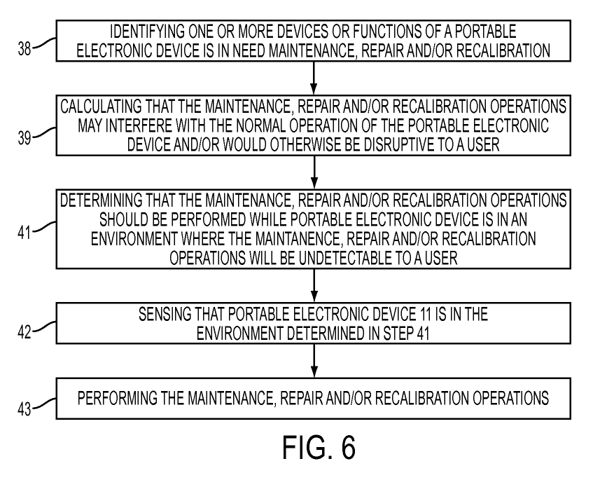

Referring to FIG. 6 a flow chart of another embodiment of a service or maintenance process is disclosed. In this embodiment, in step 38, controller 17 determines that one or more devices or functions of smartphone 11 are not operating properly or are otherwise in need of maintenance, repair and/or recalibration. At step 39, controller 17 calculates that these of maintenance, repair and/or recalibration operations are such that they would interfere with the normal operation of the portable electronic device and/or would otherwise be disruptive to a user. At step 41, controller determines that the maintenance, repair and/or recalibration operations should be performed when portable electronic device 11 is in an environment where the maintenance, repair and/or recalibration operations will be undetectable to user 21. At step 42, controller 17 and sensors 18 determine that portable electronic device 11 is in the environment determined in step 41, that is, where the operations will be undetectable to a user. At step 43, controller 17 directs that the maintenance, repair and/or recalibration operations are performed for as long as the operations on the portable electronic device remain undetectable to user 21.

While the disclosed embodiments have been described as applied to a smartphone 11, it should be expressly understood that the methods and systems described herein may find applicability to other portable electronic devices such as laptop computers, tablets, portable media devices and the like. The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not target to be exhaustive or to limit the embodiments to the precise forms disclosed. It will be apparent to one of ordinary skill in the art that many modifications and variations are possible in view of the above teachings.

We claim:

1. A method for maintaining a portable electronic device comprising the steps of:
identifying one or more devices or functions of said portable electronic device that is in need of a maintenance, repair, and/or recalibration operation;
calculating that said operation may be disruptive to a user of said portable electronic device;
determining that said opera on should be performed when said device is remote from said user;
sensing said device being remote from a user; and
performing said maintenance operation.

2. The method of claim 1 wherein said step of sensing is done by one or more sensors and a controller associated with said portable electronic device.

3. The method of claim 1 wherein said sensors and said controller determine that said user is sleeping.

4. The method of claim 1 wherein said sensors and said controller determine that said portable electronic device is not in use by said user.

5. The method of claim 1 wherein said sensors and said controller determine that said portable electronic device is being recharged.

6. The method of claim 1 wherein said sensors and said controller determine that said portable electronic device is in a sleep mode.

7. The method of claim 1 wherein said sensors and said controller determine that said portable electronic device is in a sleep mode.

8. The method of claim 1 wherein said sensors and said controller determine that said portable electronic device is at rest on a surface for a predetermined length of time.

9. The method of claim 1 wherein said sensors and said controller determine that said portable electronic device is in a low light environment for a predetermined period of time.

10. A method for maintaining a portable electronic device comprising the steps of:
identifying one or more devices or functions of a portable electronic device is in need of maintenance, repair and/or recalibration operation;
calculating that said operation may be disruptive to a user of said portable electronic device;
determining that said operation should be performed when said device is in an environment suitable for performing said operation;
sensing said suitable environment; and
performing a maintenance operation.

11. The method of claim 10 wherein said environment is such that the maintenance, repair and/or recalibration operations will be undetectable to a user.

12. The method of claim 10 wherein said environment is noisy.

13. The method of claim 10 wherein said environment is a low light environment.

14. A portable electronic device comprising:
a housing;
a plurality of electronic components associated with said housing, said components including a controller;
a plurality of sensors associated with said controller; and
whereby said controller and said sensors determine that a maintenance function should be performed on said portable electronic device and that said function should be performed undetected by a user of said portable electronic device.

15. The portable electronic device of claim 14 wherein said function is performed when said user is remote from said device.

16. The portable electronic device of claim 14 wherein said function is performed when said user is sleeping.

17. The portable electronic device of claim 14 wherein said function is performed when said device is in an environment which makes said function undetectable to a user.

18. The portable electronic device of claim 14 wherein said environment is a noisy environment.

19. The portable electronic device of claim 14 wherein said environment is a dark environment.

20. The portable electronic device of claim 14 wherein said sensors include at least one of an accelerometer, gyrometer, proximity sensor, ambient light sensor, magnetometer, liquid contact sensor, programmable pulse generator, microphone, light sensor, and ultrasound sensor.
